(19) United States
(12) Patent Application Publication
(10) Pub. No.: US 2008/0095333 A1
(43) Pub. Date: Apr. 24, 2008

(54) SYSTEM AND METHOD OF COMMUNICATING INTERNET USER INFORMATION TO SERVICE PROVIDERS

(75) Inventor: Geoffrey Trever Tudor, Austin, TX (US)

Correspondence Address: TOLER LAW GROUP, 8500 BLUFFSTONE COVE, SUITE A201, AUSTIN, TX, 78759, US

(73) Assignee: Voicebutton, LLC, Austin, TX (US)

(21) Appl. No.: 11/859,656

(22) Filed: Sep. 21, 2007

Related U.S. Application Data
(60) Provisional application No. 60/852,511, filed on Oct. 18, 2006.

(51) Int. Cl. H04M 3/02; G06F 15/16; G10L 13/00

(52) U.S. Cl. 379/88.17; 704/260; 709/206

(57) ABSTRACT

A method of communicating with a service provider is disclosed that includes receiving an email message, identifying the service provider after evaluating content in the email message, and generating an audio message including audio content derived from at least a portion of the content in the email message. The method also includes placing a first call to the service provider and communicating the audio message during the first call.

### CROSS REFERENCE TO RELATED APPLICATION(S)

This application is a non-provisional Patent Application of and claims priority from U.S. Provisional Patent Application No. 60/852,511, filed on Oct. 18, 2006, and entitled “METHOD AND SYSTEM FOR AUTOMATICALLY CONNECTING PHONE CALLS THROUGH AN EMAIL PARSING ENGINE,” which is incorporated herein by reference in its entirety.

### FIELD OF THE DISCLOSURE

The present disclosure relates to a system and method of communicating Internet user information to service providers.

### BACKGROUND

Internet searches are becoming an increasingly important part of the process of connecting consumers with service providers. Companies such as Amazon.com® and eBay.com® use Internet searches to funnel customers to their website, where electronic commerce (ecommerce) transactions can be made. In the case of goods, such as digital video discs (DVDs) and consumer electronics, it is often unnecessary for the prospective purchaser to be connected with a human being during the purchase process.

A large part of the economy, however, is based on services. For these services, it is often necessary to speak with a service provider before concluding a transaction. While close to 200 million Internet searches are conducted daily as of the summer of 2006, millions of these searches may relate to issues that require a human conversation before successfully fulfilling a consumer's request.

Several companies have created technologies for linking together the Internet to the telephone system. Companies such as Ingenio®, CallSource®, eStara®, and others have created “click to call” systems whereby a user enters their phone number in a pop-up window, and the system automatically generates a phone call between the Internet user and a service provider. For example, a user experiencing trouble booking a flight on an airline's website might be offered a “click to call” button where they can enter their phone number and an agent will call them back.

While current “click to call” services are advantageous to service providers and consumers, such services typically require integration with a website. Further, there are numerous small business service providers that may not have websites and thus cannot use conventional click-to-call services.

There are a number of companies that could benefit from “click to call” capabilities but do not have websites that support this technology. Therefore, it can be appreciated that there is a significant need for a system and method that permits automated calling of internet generated leads, but without requiring integration into a website.

Companies such as United World and Kallbak have created systems to provide for lower-rate telephone calls using call back systems. Callback systems provide a way to avoid high international tariffs when placing international phone calls, by originating calls in a low-tariff country to the international traveler, and then using that originating country to make an outbound call to a receiving party. However, such systems do not solve the problem of connecting Internet leads to service provides.

### SUMMARY

The present disclosure is directed to a novel and improved system and method for connecting Internet users and service providers using an automated email-parsing engine.

In a particular embodiment, a method of communicating with a service provider is disclosed that includes receiving an email message, identifying the service provider after evaluating content in the email message, and generating an audio message including audio content derived from at least a portion of the content in the email message. The method also includes placing a first call to the service provider and communicating the audio message during the first call.

In another particular embodiment, an email parsing engine receives an email, analyzes information contained in the email including an email recipient, a “from” address, a subject matter, a body of the email and any attachments. Based on the information contained in the email, the email parsing engine determines if a call should be made, and selectively places the call between a service provider and an Internet user, such as an Internet searcher.

Accordingly, a system is disclosed that connects Internet users with service providers by analyzing the content of an email, identifying an appropriate service provider, and generating one or more calls to connect the service provider to the Internet user.

In a particular embodiment, a system for the automatic generation of phone calls between two parties in response to the extraction of information contained within an email based on an email template is disclosed. The system includes a mail server, an email parsing engine that can extract specific information from an email including a phone number based on delimiters, a database containing information that is used to identify the email and extract specific information from the email including the delimiters, and a call server that can initiate calls.

In still another particular embodiment the system includes a unique account identifier in the “To:” address of the email that is used to lookup the phone number of one of the parties to call, and includes the ability to have an array of phone numbers to dial in order to find a live person to take the first call before making a bridging call to the second number. The system may automatically build a text-to-speech content string based on a text-to-speech template contained in the email template database, and then play this string to the service provider (e.g., first call) before being connected to the Internet lead (e.g., second call).

### BRIEF DESCRIPTION OF THE DRAWINGS

FIG. 1 is a diagram of a particular illustrative embodiment of a method of communicating Internet user information to service providers;

FIG. 2 is a diagram of a second particular illustrative embodiment of a system of communicating Internet user information to service providers;

FIG. 3 is a flow diagram of a particular illustrative embodiment of a method of communicating Internet user information to a service provider; and

FIG. 4 is a flow diagram of a particular illustrative embodiment of a method of receiving Internet user information at a service provider device.

### DETAILED DESCRIPTION OF THE PREFERRED EMBODIMENTS

In a particular embodiment, a method of communicating with a service provider is disclosed that includes receiving an email message, identifying the service provider after evaluating content in the email message, and generating an audio message including audio content derived from at least a portion of the content in the email message. The method also includes placing a first call to the service provider and playing the audio message during the first call.

In another particular embodiment, a method of communicating with an Internet user is disclosed that includes receiving a phone call at a service provider device. The phone call includes an audio alert including audio content derived from an email message from an Internet user. The method further includes communicating with the Internet user after the audio alert is received.

In another particular embodiment, a system is disclosed that includes an interface responsive to a network to receive an email from an Internet user. The email includes an Internet user address and email content. The system also includes processing logic adapted to extract data from the email content, to convert at least a portion of the extracted data into an audio message, to initiate a first call to a service providers to play the audio message after the first call is initiated, to initiate a second call to the Internet user, and to bridge the first call and the second call.

In still another particular embodiment, a system to generate calls is disclosed. The system includes an interface adapted to receive an email message related to an Internet user. The system also includes an email parser responsive to the interface and adapted to extract Internet user information from the email message and to extract a message body from the email message. The system further includes a text-to-speech converter adapted to convert the extracted message body into an audio message for playback via a first phone call to a service provider.

In yet another particular embodiment, a call server includes an interface to receive information related to an email message and processing logic responsive to the interface. The processing logic establishes a first call to a service provider based on the received information, generates an audio alert based on the received information for communication to the service provider via the first call, and establishes a second call to a contact associated with the received information.

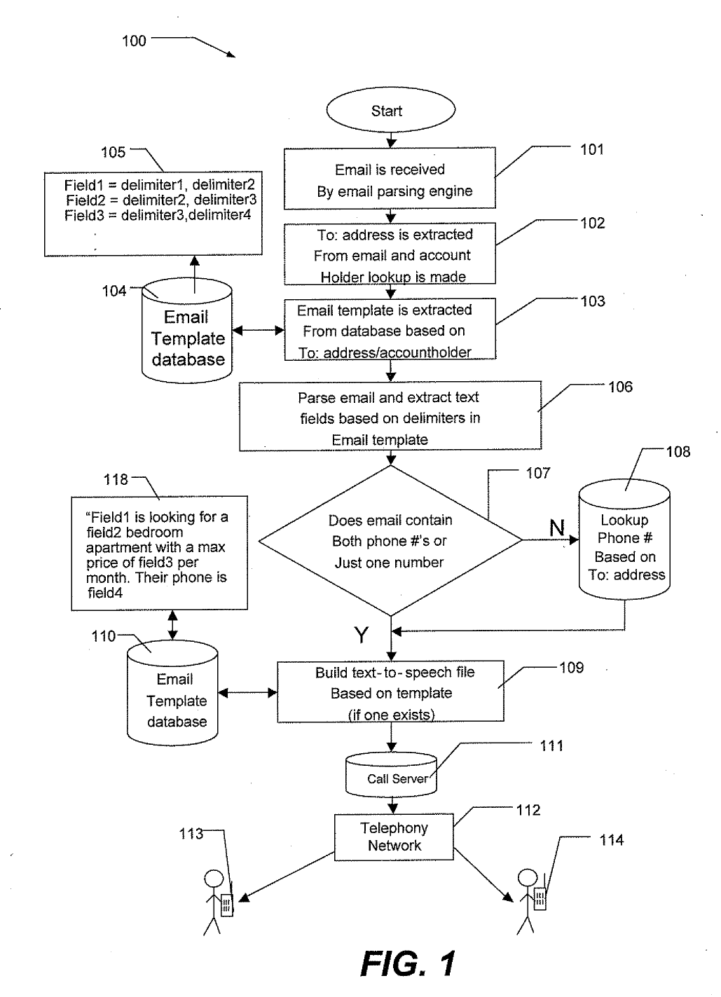

FIG. 1 is a diagram of a particular embodiment of a system 100 to communication user information to a service provider. Referring to FIG. 1, when an incoming email is received, at 101, the system 100 first looks at the “To:” address to which the email is addressed. The “To:” address is a unique identifier that matches the email with a service provider. An email parsing engine then attempts to match the “To:” address with a valid customer. The email parsing engine extracts the “To:” address from the email and an account holder lookup is made, at 102. For instance, one embodiment of the “To:” address may be call 123456@phone.voicebutton.com where call]123456@phone.voicebutton.com is a unique ID that matches a service provider that has requested phone calls to be generated from emails.

When received, the email-parsing engine then performs a database lookup for a valid account holder that matches the unique email ID described above. If a valid account holder is found, then the email-parsing engine performs a lookup to find the appropriate telephone number for the service provider.

The email parsing engine then extracts an email template (layout-map) for decoding (mapping) information in the email to a phone call from the email template database 104. The email template is extracted from the email template database 104 based on the account holder information, such as “To: address/accountholder,” at 103. The layout map contains a map of delimiters or “keywords” that are used to build information about an Internet-generated lead that is passed to the service provider to place a telephone call.

An example of the email layout map is shown at 105 and enables a system for flexibly converting the email into calls by allowing a wide variety of email types to be used. For example, instead of requiring strict field names to be used by the email sender, an existing email sample can be used to create a template that the system can use to identify where the lead's first name, last name and phone number may be extracted from the email text. This capability is especially valuable in cases where it is difficult or impossible to change the format of the email being sent, such as emails purchased by third party Internet lead generators.

An example email may be the following:
To: call10002@phone.voicebutton.com
Lead Firstname: John
Lead Lastname: Smith
Lead phone: 512-555-2356
Apartment sought:2 bedroom
Area of search: Northwest Austin

For this email, an email template could be constructed that contains fields from which desired information can be extracted for a phone call. An example email template map is as follows:
Associated with: call 10002@phone.voicebutton.com
Variable Field1: Delimiter1=“Lead Firstname:”, Delimiter2=“Lead Lastname:”
Variable Field2: Delimiter1=“Apartment sought:”, Delimiter2=“Area of search:”
Variable Phone: Delimiter1=“Lead phone:”, Delimiter2=“Apartment sought:”
(this process can be repeated for as many fields as are required to process the email)

The system 100, at 106, assigns variables: Phone, Field1, Field2, . . . Fieldn, etc., by parsing the text of the email, stripping out the text between the two fields, and storing the extracted text into local computer memory.

At 107, a lookup is performed to determine if the email contains not only the lead's phone number, but also a second phone number to be called. If the second phone number does not exist in the email template, then the system, at 108, looks-up the phone number of the service provider using the account holder code, accessed at 102. This phone number is then returned from the database lookup, at 108.

The system 100 accesses the email template database 110 for a text-to-speech map corresponding to the unique “To:” address of the email, and the system 100 builds a text-to-speech file based on the template, if one exists, at 109. An example of a database entry is shown at 118. The database entry includes a sentence structure with the variables in their appropriate place. For instance, the database template may include fields in a pre-existing structure, such as “$Field1 is looking for a $Field2 apartment. Their phone number is $Phone” for an apartment lead service provider. The system 100 can build the text-to-speech file, at 109, and the variables can be substituted with the information collected from the email template. For example, when the text-to-speech file is read-in, based on the example email above, it would be read to the end user as “John is looking for a 2 bedroom apartment. Their phone number is 512-555-2356.”

The above method enables the system 100 to allow the service provider to learn the information submitted by the lead via the form without requiring the lead to repeat all of the requested information again. This enables the service provider to provide a higher quality of service to the lead by informing a representative of the service provider what the lead is looking for before initiating the call to the lead. This method also enables the service provider to have a distributed workforce that can respond intelligently to Internet leads without having to always be in front of their computers.

Returning to 109, after the text-to-speech file is built, the method advances to 111 and a telephone call is triggered by the email parsing engine to a call server. Such call servers are available by third parties such as Excel Communications, Exgen, LLC, other companies, or any combination thereof. These call servers are gateways that can create and transmit calls using voice over IP networks, wireless telephony networks and traditional landline networks, such as the public switched telephone network (PSTN), at 112.

The system 100 can call either of the phone numbers (herein referred to as service provider and Internet lead) dependent upon settings, at 112, in the account bolder profile, as determined at 103. However, for illustration purposes, an example of calling the service provider first is provided.

The first call is made from a call server, at 111 via the telephony network 112 to a service provider representative 113. Once the service provider representative 113 answers the call, the text to speech information is played to them, and the called party (i.e., service provider representative 113) is given the option to press a key to be connected with an Internet lead 114. This keypress might be any confirmation key, such as a “1” or “#” or “*” key, or combination of keys.

This step of obtaining an affirmative action before being transferred to the lead is optional, but it is illustrated because it addresses the problem of having the service provider's voicemail pick-up and then connecting the lead to the service provider's answering machine or voicemail system.

In an alternative embodiment when the first call is made, as shown at 111, 112, and 113, the system asks the service provider to affirmatively “accept the call” by pressing a key before receiving the lead's information in text-to-speech form.

This alternative embodiment may be preferred by some service providers because, if a keypress is not received, the lead's text-to-speech message is not left in the voicemail box of the service provider. This is helpful because there may be other phone numbers that the service provider wishes to “dial-down” until an affirmative response is received. For example, the service provider may have a number of representatives to which a particular lead may be routed. If a first representative is unavailable or does not accept the call, another call may be placed to a different representative. In this example, the lead's text-to-speech information is played to the service provider after the keypress is received but before the phone call is transferred to the Internet lead.

Once the keypress is received, the call server initiates a second outbound call to the phone number of the Internet lead, at 114. Once this second call is made, the call server bridges the call between the service provider representative, at 113, and the Internet lead, at 114, such that a conversation may take place. At the option of the service provider, the call server may record the conversation between the two parties.

The example use of the disclosed system of connecting a service provider representative and an Internet lead is for illustrative purposes only. The example use in no way is meant to limit the scope of people that may desire to communicate based on email-triggered calls.

The disclosed system enables emails to be used to trigger calls between Internet leads and service providers, or between other parties, without having to implement or integrate specific click-to-call technology on websites.

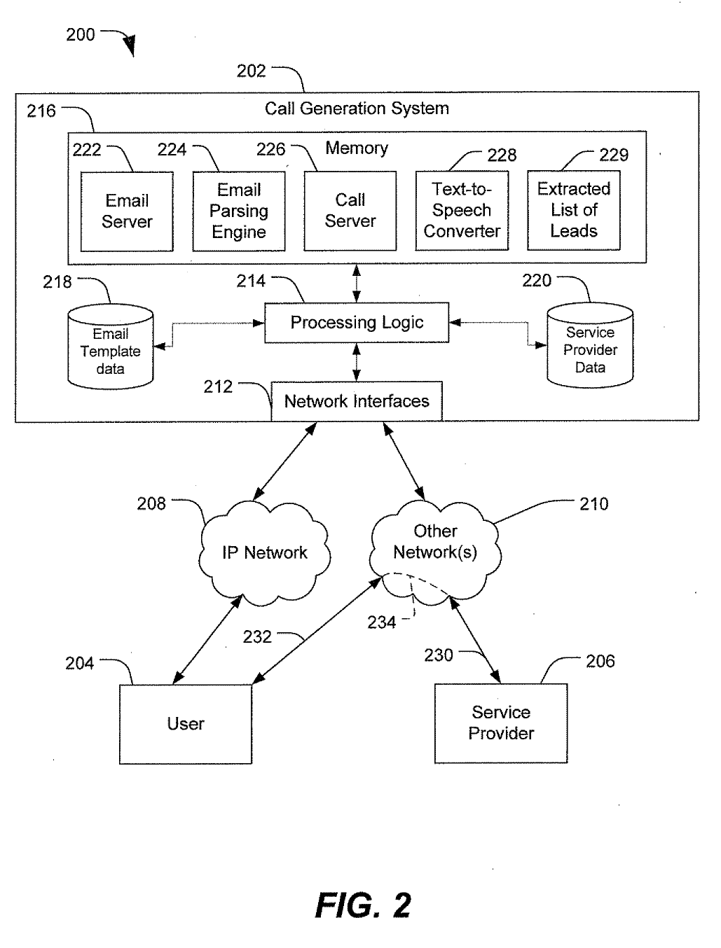

FIG. 2 is a diagram of a particular illustrative embodiment of a system 200 of communicating Internet user information to service providers. The system 200 includes a call generation system 202 that can receive emails from a representative Internet user 204 via an Internet Protocol (IP) network 208 and that can communicate with a device associated with the Internet user 204 and with a device associated with a service provider representative 206 via another network 210, such as a public switched telephone network (PSTN), a wireless network, another network, or any combination thereof. In a particular embodiment, the system 200 can communicate with a device associated with the Internet user 204 and with a device associated with the service provider representative 206 via the IP network 206, one or more other networks 210, or any combination thereof: In a particular embodiment, the devices associated with the user 204 and with the service provider representative 206 may be communication devices, such as wireless telephones, landline telephones, personal digital assistants (PDAs) with bi-direction voice communication functionality, personal computing devices adapted to receive calls, or any combination thereof.

The call generation system 202 includes one or more network interfaces 212 that are responsive to the IP network 208 and to the one or more other networks 210. The call generation system 202 also includes processing logic 214 coupled to the one or more network interfaces 212 and a memory 216 accessible to the processing logic 214. The call generation system 202 may also include an email template database 218 and a service provider database 220. The memory 216 includes instructions executable by the processing logic 214. For example, the memory 216 includes an email server 222 executable by the processing logic to receive email messages. The memory 216 also includes an email parsing engine 224 executable by the processor to parse a received email to extract “To:” address information and to retrieve a text-to-speech mapping template related to the extracted “To:” address information from the email template database 218. For example, the call generation system 202 may be adapted to receive emails from different sources that are related to multiple service providers. Such emails may contain information that is organized in different ways, and each service provider may have one or more templates to map the email text to particular data fields. The email-parsing engine 224 is adapted to populate the retrieved text-to-speech mapping template with data extracted from the email. The email parsing engine 224 is adapted to determine whether the email includes service provider contact information and, if not, to retrieve the service provider contact information from the service provider database 220.

The memory 216 also includes a call server 226 that is executable by the processing logic 214 to initiate a first call 230 to a service provider according to the service provider contact information. The memory 216 also includes a text-to-speech converter 228 to convert the data extracted from the email to an audio message based on the text-to-speech mapping template. The call server 226 is adapted to play the audio message to the service provider (i.e., a service provider representative) via the first call 230. In a particular example, the first call 230 is initiated by the call server 226 and may include a user selectable option indicating whether the service provider representative wishes to be connected to the Internet user that initiated the email message. In response to a selection related to the user selectable option, the call server 226 is adapted to initiate a second call 232 to the Internet user and, once connected, to bridge 234 the first call 230 and the second call 232 to allow the service provider representative to communicate with the Internet user.

Additionally, the memory 216 is adapted to store an extracted list of leads 228 (i.e., Internet users), which may be extracted from a series of email messages. The call generation system 202 may process the extracted list of leads 229 so that multiple phone numbers can be dialed successively to find a live person.

While the first call 230 and the second call 232 are indicated to form a communication link via the one or more other networks 210 it should be understood that the first call 230 and the second call 232 may be bridged via two different networks. Additionally, while the first call 230 and the second call 232 are illustrated as being made via the one or more other networks 210, the first call 230, the second call 232, or any combination thereof may communicate via the IP network 208, a Public Switched Telephone Network (PSTN), a wireless network, another network type, or any combination thereof.

While the call generation system 202 is illustrated as a single device, it should be understood that, in an alternative embodiment, the call generation system 202 may be a distributed system. In particular, the various functions 222, 224, 226, and 228, which are illustrated as software modules that are executable by the processing logic, may be implemented on separate devices (such as separate servers), and the processing logic may be distributed across multiple devices. In this example, the call generation system 202 may utilize message passing techniques to share information between the various servers to enable the communication of Internet user information to service providers.

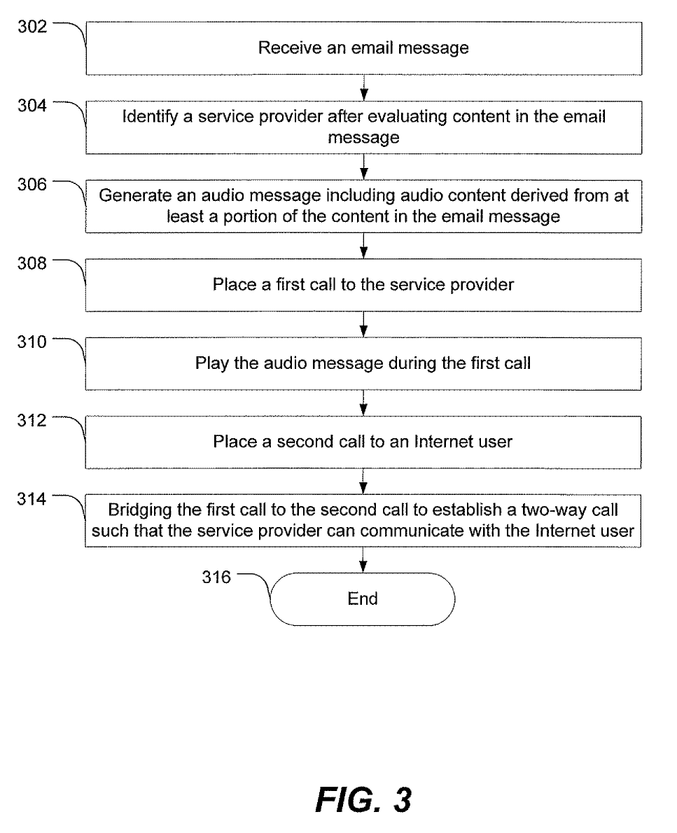

FIG. 3 is a flow diagram of a particular illustrative embodiment of a method of communicating Internet user information to a service provider. At 302, the method includes receiving an email message. The email message may include multiple fields, including a “To” address, a “From” address, and a message body. Proceeding to 304, the method includes identifying a service provider after evaluating content in the email message. In a particular embodiment, the content of the email message is evaluated by extracting data from the email message and mapping the extracted data to an email template. In a particular example, the message body of the email message may include a phone number associated with an Internet user, which may be extracted and recognized as a phone number by an email parsing engine.

Advancing to 306, the method includes generating an audio message including audio content derived from at least a portion of the content in the email message. In a particular embodiment, the audio content may be derived from at least a portion of the content based on a text-to-speech conversion of text from the email message. For example, the audio content may be derived from the content of the message body. In another example, the audio content may be derived from a particular field within the message body. Continuing to 308, the method includes placing a first call to the service provider (i.e., to a contact number associated with the service provider). In a particular example, the contact number may be embedded within the received email message. In another particular example, a call generation system may retrieve the contact number from a service provider database. Alternatively, the call generation system may be adapted to search various network resources for the service provider contact number.

Moving to 310, the method includes playing the audio message during the first call. Proceeding to 312, the method includes placing a second call to an Internet user. At 314, the first call and the second call are bridged to establish a two-way call such that the service provider can communicate with the Internet user. The method terminates at 316.

In a particular example, the first call may be placed via an Internet Protocol network (i.e., a Voice over Internet Protocol (VoIP) call). In another example, the first call may be placed via a Public Switched Telephone Network (PSTN), a wireless network (e.g., a cellular network, a digital wireless network, or any combination thereof, another network, or any combination thereof. Similarly, the second call may be connected via an IP network (i.e., a VoIP call), a PSTN, a wireless network, another network, or any combination thereof Regardless of the network on which the first call or the second call originates, the call generation system is adapted to bridge the first call and the second call to facilitate communication between the service provider representative and the Internet user.

In a particular embodiment, the call generation system may include a user selectable option within the first call. For example, after the audio message is played at step 310, the call generation system may present a voice menu providing at least one user selectable option for the call recipient (i.e., a service provider representative) to elect to be connected to the Internet user. In response to a selection indicating a desire to be connected, the call generation system may initiate the second call and bridge the first and second calls (i.e., 312 and 314). Alternatively, if the service provider representative declines to be connected, an audio message associated with a different email message may be played to the service provider representative.

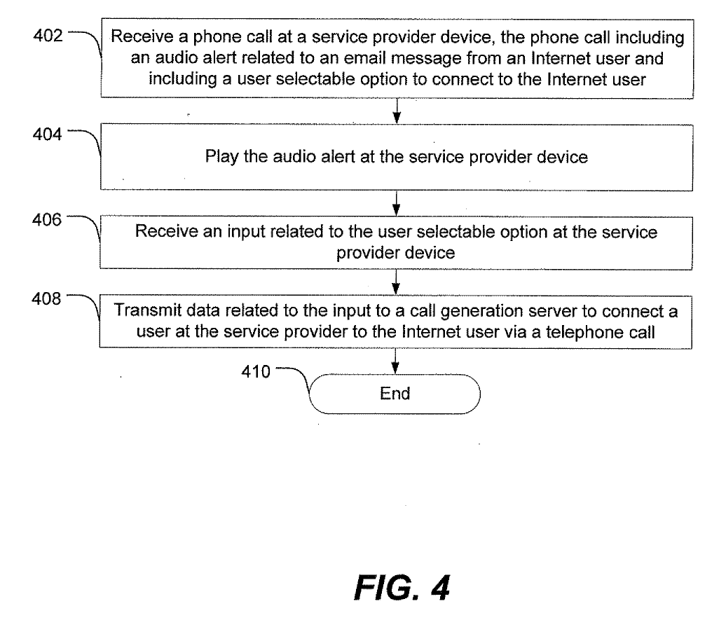

FIG. 4 is a flow diagram of a particular illustrative embodiment of a method of receiving Internet user information at a service provider device. The method includes receiving a phone call at a service provider device, at 402. The phone call includes an audio alert related to an email message from an Internet user and may include a selectable option to connect to the Internet user. Advancing to 404, the method includes playing the audio alert at the service provider device. Continuing to 406, the method includes receiving an input related to the selectable option at the service provider device. The selectable option may include a voice menu with which the service provider representative may interact by pressing keys on the keypad of his/her phone. Moving to 408, the method includes transmitting data related to the input to a call generation server to connect a representative at the service provider to the Internet user via a telephone call. The call generation server is adapted to initiate a second call to the Internet user and to bridge the first call and the second call to facilitate communication. The method terminates at 410.

In general, it should be understood that the particular methods illustrated in FIGS. 3 and 4 are intended as examples only, and should not be construed as limiting. Additionally, it should be understood that particular steps may be omitted in certain implementations. For example, in FIG. 4, it may be desirable to automatically connect the service provider representative to the Internet user after playing the audio alert and without receiving input from the representative (as described with respect to 406). Alternatively, elements may be added to the methods described with respect to FIGS. 3 and 4. For example, in FIG. 4, a decision node may be added between 406 and 408, such that if the service provider representative elects not to be connected, the call generation system may receive a new audio alert from an extracted list of leads and return to 404, where the new audio alert can be played at the service provider device.

In general, the memory 216 that is illustrated in FIG. 2 and other discussion of databases may be understood to refer to computer-readable media. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of communicating with a service provider, the method comprising:
receiving an email message;
identifying the service provider after evaluating content in the email message;
generating an audio message including audio content derived from at least a portion of the content in the email message;
placing a first call to the service provider; and
playing the audio message during the first call.

2. The method of claim 1, wherein the email message is sent from an Internet user.

3. The method of claim 2, further comprising placing a second call to the Internet user.

4. The method of claim 3, wherein the second call is placed using a telephone number extracted from the email message.

5. The method of claim 3, further comprising bridging the first call to the second call to establish a two-way call such that the service provider can communicate with the Internet user.

6. The method of claim 2, wherein the Internet user is an Internet generated sales lead.

7. The method of claim 2, wherein the Internet user is identified by a particular field within the email message.

8. The method of claim 1, wherein the audio content in the audio message is evaluated by performing a text to speech operation on text from the content in the email message.

9. The method of claim 1, wherein the email message includes a recipient field, a from address field, a subject matter field, and an email body field, and wherein the service provider is identified after an email parsing engine has analyzed the email message.

10. The method of claim 9, wherein the service provider is selected by the email parsing engine by evaluating data in the recipient field.

11. A system comprising:
an interface responsive to a network to receive an email from an Internet user, the email including an Internet user address and email content; and
processing logic adapted to extract data from the email content, to convert at least a portion of the extracted data into an audio message, to initiate a first call to a service provider, to play the audio message after the first call is initiated, to initiate a second call to the Internet user, and to bridge the first call and the second call.

12. The system of claim 11, wherein the at least a portion of the extracted data includes a body of an email message.

13. The system of claim 12, further comprising a database to store one or more text-to-speech templates, and wherein the processing logic is adapted to retrieve a text-to-speech template of the one or more text-to-speech templates based on the extracted data and to map data from the body of the email message to the retrieved text-to-speech template for conversion.

14. The system of claim 11, wherein the processing logic is adapted to provide a voice menu to the service provider via the first call, the voice menu including one or more selectable options.

15. The system of claim 14, wherein the processing logic is adapted to receive an input related to the voice menu and to selectively initiate the second call to the Internet user in response to the received input.

16. A system to generate calls, the system comprising:
an interface adapted to receive an email message related to an Internet user;
an email parser responsive to the interface and adapted to extract Internet user information from the email message and to extract a message body from the email message;
a text-to-speech converter adapted to convert the extracted message body into an audio message for playback via a first phone call to a service provider.

17. The system of claim 16, further comprising a call server, the call server to initiate the first phone call, to initiate a second phone call to the Internet user, and to bridge the first phone call and the second phone call.

18. The system of claim 16, further comprising a database to store one or more text-to-speech templates related to one or more service providers, each of the text-to-speech templates including one or more fields.

19. The system of claim 18, further comprising logic to search the database using data extracted from the email message and to retrieve a text-to-speech template from the database based on the data, wherein the email parser is adapted to utilize the text-to-speech template to map the Internet user information and the message body to the one or more fields.

20. A call server comprising:
an interface to receive information related to an email message; and
processing logic responsive to the interface, the processing logic adapted to establish a first call to a service provider based on the received information, the processing logic to generate an audio alert based on the received information for communication to the service provider via the first call and to establish a second call to a contact associated with the received information.

21. The call server of claim 20, wherein the processing logic is adapted to bridge the first call and the second call.

22. The call server of claim 20, wherein the processing logic comprises a text-to-speech converter to generate the audio message from the received information.

23. The call server of claim 22, further comprising a database including a plurality of text-to-speech mapping templates, wherein the processing logic is adapted to identify a text-to-speech mapping template from the plurality of text-to-speech mapping templates that corresponds to the service provider and to generate the audio alert according to the identified text-to-speech mapping template.

24. A method of communicating with an Internet user, the method comprising:
receiving a phone call at a service provider device, the phone call providing an audio alert, the audio alert including audio content derived from an email message from an Internet user; and
communicating with the Internet user after the audio alert is received.

25. The method of claim 24, further comprising playing the audio alert before communicating with the Internet user.
